(19) United States
(12) Patent Application Publication
(10) Pub. No.: US 2003/0028460 A1
(43) Pub. Date: Feb. 6, 2003

(54) Method for evaluating a patent portfolio

(76) Inventor: Sylvia K. Kraemer, Alexandria, VA (US)

Correspondence Address: Donald C. Casey, 311 North Washington Street, Suite 100, Alexandria, VA, 22314, US

(21) Appl. No.: 09/917,826

(22) Filed: Jul. 31, 2001

(51) Int. Cl. G06F 17/60

(52) U.S. Cl. 705/36; 705/1

(57) ABSTRACT

A method for valuing large portfolios of publicly owned patents is disclosed. The method includes measuring the diversity and the depth of the portfolio's contents. Density or heterogeneity consists of calculating the ratio of the number of patents to the number of patented technology classes to which the patents have been assigned by the United States Patent and Trademark Office. The depth consists of the ratio of the number of patents with referencing an original patent as prior art through two generations of referencing patents. A base line for evaluation can be the utility patents awarded by the U.S. Patent and Trademark Office for the period of 1976-2000 and over time as the heterogeneity and depth increase, the value of the portfolio increases.

### FIELD OF THE INVENTION

This invention relates to a method for evaluating a large patent portfolio, and in particular, a government or publicly owned patent portfolio which includes, preferably, more than a thousand United States patents.

### DESCRIPTION OF THE PRIOR ART

There are a number of methods for evaluating or valuing intangible property, including stocks and bonds and related financial instruments. See for example U.S. Pat. Nos. 5,930,774, 6,085,175 and 6,092,050. As is well known, when evaluating negotiable instruments standard procedure can be used to fix a monetary value on the negotiable instruments, and further, there are a variety of procedures for evaluating the risk that a particular portfolio will increase or decrease in value more rapidly than an external standard such as, for example, the Dow Jones Industrial average.

However, in the case of patents, the value is based primarily on the eventual return, in the case of commercially, or privately owned, patents. One value to be attached to a patent is the cost of securing the issuance of the patent. These costs are relatively uniform and do not essentially depend on the technology involved or the licensing potential. While the cost to obtain a patent on a biotechnical procedure or electronic advance may be greater than that to obtain a patent on a mechanical gear arrangement, in the concept of a large patent portfolio, of, for example, over a thousand patents, the costs for obtaining the same should average a reasonably uniform amount. The cost of obtaining the patent, however, has no logical relationship to the actual value over the life of the patent.

In the case of United States patents, one method of valuation could be estimating the revenue potential from licensing. Even in the case of commercially owned patents, however, there are intangible factors such as the monopoly value of a patent to be factored in. The ability to exclude others from competitive efforts would theoretically have a tangible result on the market value of a product manufactured under a patent. As compared, however, to licensing revenues, this would be a valuation element difficult to fix.

In the case of government owned or publicly owned patents there are many other intangibles to consider. For example, the publication of a patent, even if publicly owned, can stimulate research in a particular technology and there are public benefits to be derived from the presence of the printed record in a readily accessible place for research.

The United States Patent Office classifies prior art according to subject matter and therefore research in a particular area of technology can be facilitated be searching through related patents, whether they are publicly owned or commercially owned, and whether they are licensed or not.

In U.S. Pat. No. 6,175,824 there is a procedure and technique described for selecting publicly traded companies for inclusion in a stock market portfolio based upon certain patent indicators. One of the techniques used to evaluate patents is described as “ranking based upon frequently cited patents”. In other words, if a particular U.S. patent is cited by patent examiners in subsequent cases it would have a greater value than if it was not cited in any subsequent cases. It is projected that pioneering patents would be cited five times as frequently as ordinary patents and important patents were cited at least twice as frequently as those in a control group.

This patent, however, recognizes that there are substantial barriers to formatting patent indicators for a company's portfolio. Specifically, there is a problem with matching patent assignments to specific companies. As is well known, companies may take ownership of patents in a holding company which has no other assets which is separate from the operating company. Furthermore, there is no requirement that a patent assignment actually be recorded in the U.S. Patent Office. An inventor can validly assign a patent to a company without recording the same in the United States Patent Office. In addition, licenses are not required to be recorded. The patent law does not mention the recording of either exclusive or non-exclusive licenses. Furthermore, corporations acquire other corporations, divest themselves of divisions or corporations, and merge. The recording of a transfer of a patent portfolio may be delayed substantially depending on business considerations.

The above referenced U.S. Pat. No. 6,175,824 was directed to a method for measuring the quality of a company's technology based on the proposition that a strong patent portfolio should lead to a strong likelihood that the company owner would be a strong candidate for inclusion in a stock market portfolio. These considerations, though, have very little to do with the considerations pertinent for evaluating a publicly owned portfolio, such as that of a government agency, a state government, or a university.

Up until 1980 patents on inventions made with public funds were in the public domain. However, with the amendment to the patent and trademark laws, Public Law 96-517, federal agencies were authorized to grant exclusive or partially exclusive licenses on inventions covered by federally owned domestic patents or patent applications based upon an agency determination. Preference in issuing exclusive or partially exclusive licenses was to be given to small business firms, and the government retained royalty free licenses to contractor made inventions.

Nonprofit organizations as well as small businesses could elect to retain title to inventions made under federally funded agreements. Therefore, after the passage of the amendment, inventions which were made with public funds could be licensed exclusively to parties capable of pursuing commercialization of the invention.

In the case of government owned patents there is a requirement that the patent identify the government as owner. Therefore, identifying which patents are publicly owned, and by which agency, is not the problem it would be in the case of commercially owned patents. On the other hand, the licensing potential as an evaluation factor is very complicated due to the fact that licenses are not recorded, the government retains a non-exclusive license in the invention, and the grant of the exclusive license is dependent upon a find of non-interest.

Prior methods of evaluating patent portfolios depending on citing monetary values have very little validity. Accordingly, there is a need to develop a method for valuing large patent portfolios, and in particular, to evaluate large scale intellectual assets which are publicly owned.

### SUMMARY OF THE INVENTION

It has been discovered that capital portfolios consisting of, preferably, greater than one thousand patents can be valued by measuring the diversity, (heterogeneity and balance), and depth of the portfolio's contents. Heterogeneity would consist of the ratio of the number of patents at any given time to the number of patent technology classes to which the patents have been assigned by the United States Patent Office. Depth consists of the ratio of the number of successive patents referencing an original patent as prior art through two generations of referencing patents.

The nominal baseline for heterogeneity is the distribution of all utility patents awarded by the USPTO among USPTO technology classes for the period of 1976-2000, updated annually. The nominal baseline for depth is the average ratio of first and second generation patent references, for all utility patents awarded by the USPTO for the period 1976-2000, updated annually. As heterogeneity and depth increase, the value of the portfolio increases. When heterogeneity and depth ratios are the same the portfolio can be described as balanced, and this model is dynamic in that heterogeneity and density will increase or decrease continually as new utility patents are assigned to classes, over time, by the USPTO.

Accordingly, it is an object of this invention to provide a method for evaluating a publicly owned patent portfolio.

It is another object to provide a method for evaluating a patent portfolio consisting of greater than about one thousand patents.

It is still another object to provide a dynamic model which can be used to provide a evaluation of a large publicly owned patent portfolio which will change over time to reflect newly issued and expiring patents.

These and other objects will become readily apparent with reference to the following drawing and description wherein:

### BRIEF DESCRIPTION OF THE DRAWING

FIG. 1 is a schematic of the model of this invention.

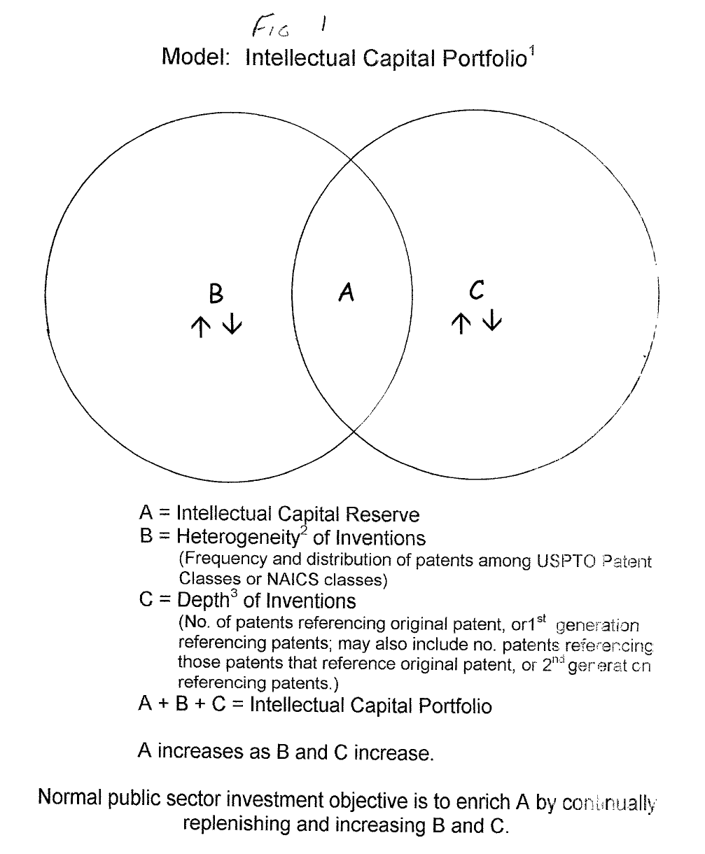

### DETAILED DESCRIPTION OF THE INVENTION

The justification for federal research, development, and spending is that it is an investment. If federally funded technological innovation is regarded as a capital investment it should be subject to valuation. Clearly the value of such a portfolio is reflected in more than an aggregate of dollars generated. Statistical, educational and occupation data on scientists and engineers, routinely collected as “indicators” of human resources actually tell little about how effectively those resources have been used. It has been discovered, however, that it is possible to determine reasonable equivalents of portfolio diversity and risk from much of the intellectual property data currently being collected by federal agencies and by the U.S. Patent and Trademark Office. Currently available data allows us to establish baselines or reference points from which is possible to ascertain what constitutes “more” or “less” portfolio diversity and risk. Once baselines have been established policy decisions can be made about the relative allocation of federal R&D investments among various technologies, programs, and federal institutions. Such data can be modeled so that increases or decreases in portfolio balance and risk can be displayed dynamically.

There are two elements to be determined in valuing a portfolio of government owned patents. These two factors are balance or diversity, and the risk or depth.

Concerning balance or diversity, the USPTO assigns all patents to one of about 450 classes, or technological categories. The distribution of patents in a portfolio among these classes can be ascertained and compared with a baseline consisting of the average distribution of all utility patents. The time-span under consideration is 1977-1999, which is the time-span of the most recent USPTO report on patent classifications. In this case, “average” would serve as a norm against which the class distribution of a patent portfolio of a federal agency might be compared.

In order to establish the risk or “depth” the number of citations of patents in prior art should be accumulated. For example, an issued United States patent will have printed on its face a list of the prior references cited by the examiner as pertinent. The references can be cited by the inventor, but the patent examiner must agree to indicate that the references cited are “prior art”. It is possible, then, to infer from the frequency of patent references that a certain degree of activity is occurring in a particular field of technology. The greater the number of citations the larger the degree of activity. If a great deal of activity is taking place the likelihood of significant improvement occurring is greater than in areas where few people are investing time and effort.

When an increasing number of patents in a particular portfolio are cited in subsequent patents to a greater degree than the average for all U.S. patents during the same period of time the portfolio would be increasing in depth. The greater the depth of the intellectual capital portfolio, the greater the probability that one or more inventions will produce a marketable product, and the smaller the risk that R&D resources shall have been invested with negligible prospects of return.

Both values, then, portfolio balance (heterogeneity) and portfolio depth (risk) can be expressed as simple percentages or ratios. As one or both variable increases the value of the portfolio increases. For individual investors or private sector firms such a model is not as useful because of its large scale. However, for very large intellectual property portfolios held by governments making “public good” investments such a model offers more valid research policy guidance than statistical trends of aggregate patents owned and licenses issued.

### EXAMPLE

To illustrate, patents issued to, and waivers of patent rights issued by, the National Aeronautics and Space Administration (NASA), from 1976 to 1996, have been evaluated as described above. NASA ranks in the top fourth in all federal agencies performing R&D, in three key measures: R&D funding, productivity, and technology transfer:, i.e. funding, patents received, and licenses issued. The research spans almost the second half of the twentieth century.

As the baseline for the heterogeneity of NASA patents issued during 1976-1996 the heterogeneity, or distribution among technology classes, of all U.S. utility patents issued during that same time was used. Because of the large volume of data only those patents whose numbers exceed the average distribution of the respective patents sets among patent classes were considered.

The arithmetic average patent class distribution, for all U.S. patents issued during 1977-1999, is 2,188,791, distributed equally among 451 patent classes, or 4,853 (0.22%) patents per class. Nearly one half of all U.S. Patents with a more than average distribution among technology classes was assigned to only 38 classes out of a possible 255. In descending order the seven classes containing 1% or more of U.S. patents were “drug, bio-affecting and body treating compositions” (Class 514) (2.3%), “stock material or miscellaneous articles” (1.7%), “measuring and testing” (1.2%), “chemistry:molecular biology and microbiology” (1.2%), “radiation imagery chemistry” (1.1%), “internal combustion engines” (1%), and “drug, bio-affecting and body treating compositions” (Class 424) (1%). As will be evident, two of these classes are generic technologies and two biotechnologies. The biotechnology classes, classes 514 and 424, represent a greater proportion of all U.S. patents than the next most frequently technology classes (3.3% v. 1.7%).

During roughly the same period, 1976-1996, NASA was granted 2,621 U.S. patents, which represents about 10% of all patents issued to the federal government (23,951) during the same period. The federal government's share of all patents issued by the USPTO during that period was 3.2%. During that period NASA issued 1,716 waivers of patent rights to inventions made by contractors and grantees. Up until 1983 NASA could, for various reasons, deny requests from contractors for waivers of patent rights for inventions made under their contract, and the agency denied 11 requests during the first half of the period in question.

The following is a summary of the NASA analysis. The class to ratio of NASA's patents for the period in question was 1:58 patents, or 0.22% of NASA patents per class 42% of all patents assigned to NASA exceeded the average of this baseline. These patents were distributed among only 35 patent classes (or 16%) out of a possible 225. Comparing the distribution of 1% or more of all U.S. patents and 1% or more of all NASA patents reveals that for all U.S. patents only 9.5 were distributed at the rate of 1% or more per class, and only 7 classes contained 1% or more patents. In NASA's case 28% of the agency's patents were distributed at the rate of 1% or more per class, among 10 classes. It can then be concluded that NASA's patent inventions were more richly constituted than its counterpart among all U.S. patented inventions over approximately the same period of time. Such a conclusion would confirm that aerospace engineering, development, and operations engage a wider array of technologies and even a broader array of newer technologies than one finds among the entire range of U.S. patented inventions.

Concerning the depth of portfolio, this analysis entails determining the frequency with which U.S. patents are referenced in subsequent patents as “prior art”. High technology products combine numerous patented innovations, and extensive patenting “around” an invention can operate as an offensive as well as defensive business strategy.

The distribution of numbers of referencing patents among patents referenced for 202 randomly sampled U.S. patents, 1977-1996, was the basis for analysis. This analysis showed that a typical patent has a good chance of being referenced as prior art in at least four subsequent patents, while a patent that is referenced in 10 subsequent patents is unusual. The average ratio of original patent to subsequent referencing patents is 1:8. Comparing the number of referencing patents to the number of NASA patents referenced for the two sample years, 1976 and 1993, the ratios of 1:5.3 and 1:2.7 were found. A reasonable conclusion, then is that while NASA's inventive activity reaches across a wider array of technologies than is true for the nation in general, the degree of interest in the areas of innovation in which NASA is active is less than the degree of general interest in the technologies in which all U.S. inventors are active.

In summary the available data allows the evaluation the public interest in research and development against attributes that are desirable to evaluate in connection with an investment portfolio, i.e., balance and risk. The distribution of patents among the USPTO technology classes allows a judgment as to the extent to which the investment is excessively concentrated in some areas or neglected in other areas. The extent to which patent inventions occur in a crowded art enables a judgment as to the probability that some inventions are likely to become adopted for commercially successful products.

It would be expected that the technology distribution of patents issued to a federal agency conducting research and development as part of its mission would be less heterogeneous than the technology distribution of all U.S. patents in general. Instead, the NASA patents show a more heterogeneous distribution than the sampling of U.S. patents in general. U.S. patents in general are concentrated in biotechnologies and an analysis of first generation patents referencing a randomly sampled set of U.S. patents shows the same tendency to concentrate around a small number of technology fields which is a tendency somewhat less pronounced in a comparable analysis of NASA patents randomly sampled from the same period.

Finally, the model proposed herein offers a more reliable basis for randomly selecting case studies of successful and failed efforts to commercialize technological innovations resulting from the work of federal research and development agencies.

It will be readily seen by one of ordinary skill in the art that the present invention fulfills all of the objects set forth above. After reading the foregoing specification, one of ordinary skill will be able to effect various changes, substitutions or equivalents and various other aspects of the invention as broadly disclosed herein. It is therefore intended that the protection granted hereon be limited only by the definition contained in the appended claims and equivalents thereof.

In the claims:

1. A method for valuing a large publicly owned patent portfolio comprising the steps of measuring the diversity and depth thereof wherein diversity is the ratio of the number of patents to the number of technological classes to which the patents have been assigned by the United States Patent and Trademark Office and depth is the ratio of the number of successive patents referencing an original patent through two generations of referencing patents.

2. The method of claim 1 wherein the portfolio consists of at least about one thousand United States patents.

3. The method of claim 1 wherein said valuation is calculated with reference to a base line consisting of all U.S. patents issued from 1976-2000.
